(19) United States
(12) Patent Application Publication
(10) Pub. No.: US 2020/0249603 A1
(43) Pub. Date: Aug. 6, 2020

(54) FIXING DEVICE AND IMAGE FORMING APPARATUS

(71) Applicants: Yasunori ISHIGAYA, Kanagawa (JP); Yoshio HATTORI, Kanagawa (JP); Yoshikuni SASAKI, Kanagawa (JP); Hironori YAMAOKA, Tochigi (JP); Takahiro IMADA, Kanagawa (JP); Takumi WAIDA, Kanagawa (JP)

(72) Inventors: Yasunori ISHIGAYA, Kanagawa (JP); Yoshio HATTORI, Kanagawa (JP); Yoshikuni SASAKI, Kanagawa (JP); Hironori YAMAOKA, Tochigi (JP); Takahiro IMADA, Kanagawa (JP); Takumi WAIDA, Kanagawa (JP)

(73) Assignee: Ricoh Company, Ltd.

(21) Appl. No.: 16/726,941

(22) Filed: Dec. 26, 2019

(30) Foreign Application Priority Data
Feb. 1, 2019 (JP) 2019-016731

(51) Int. Cl. G03G 15/20

(52) U.S. Cl. CPC G03G 15/2053; G03G 15/2042; G03G 2215/2003; G03G 15/2064; G03G 15/2032

(57) ABSTRACT

A fixing device includes a first rotator and a second rotator disposed opposite the first rotator. A heater heats one of the first rotator and the second rotator. A cleaner is disposed opposite the second rotator. A temperature detector is disposed opposite the second rotator at an opposed position being within an increased conveyance span where a first sheet is conveyed and being outboard from a decreased conveyance span in an axial direction of the second rotator where a second sheet smaller than the first sheet is conveyed. The temperature detector detects a temperature of the second rotator. A mover moves the cleaner between a contact position where the cleaner contacts the surface of the second rotator and a separation position where the cleaner separates from the surface of the second rotator based on the temperature of the second rotator, that is detected by the temperature detector.

### CROSS-REFERENCE TO RELATED APPLICATION

This patent application is based on and claims priority pursuant to 35 U.S.C. § 119(a) to Japanese Patent Application No. 2019-016731, filed on Feb. 1, 2019, in the Japan Patent Office, the entire disclosure of which is hereby incorporated by reference herein.

### BACKGROUND

### Technical Field

Exemplary aspects of the present disclosure relate to a fixing device and an image forming apparatus, and more particularly, to a fixing device and an image forming apparatus, such as a copier, a printer, a facsimile machine, and a multifunction peripheral (MFP) having at least two of copying, printing, facsimile, scanning, and plotter functions, or the like, that incorporates the fixing device.

### Discussion of the Background Art

Related-art image forming apparatuses, such as copiers, facsimile machines, printers, and multifunction peripherals (MFP) having two or more of copying, printing, scanning, facsimile, plotter, and other functions, typically form an image on a recording medium according to image data by electrophotography.

Such image forming apparatuses include a fixing device that includes a fixing rotator, a pressure rotator, and a cleaner that contacts and cleans a surface of the fixing rotator or the pressure rotator. The cleaner contacts and separates from the fixing rotator or the pressure rotator.

### SUMMARY

This specification describes below an improved fixing device. In one embodiment, the fixing device includes a first rotator that rotates in a first rotation direction and a second rotator that rotates in a second rotation direction. The second rotator is disposed opposite the first rotator to form a nip between the first rotator and the second rotator, through which a first sheet having a first width in an axial direction of the second rotator and a second sheet having a second width smaller than the first width in the axial direction of the second rotator are conveyed. A heater heats one of the first rotator and the second rotator. A cleaner is disposed opposite the second rotator. A temperature detector is disposed opposite the second rotator at an opposed position being within an increased conveyance span in the axial direction of the second rotator where the first sheet is conveyed. The opposed position is outboard from a decreased conveyance span in the axial direction of the second rotator where the second sheet is conveyed. The temperature detector detects a temperature of a surface of the second rotator. A mover moves the cleaner between a contact position where the cleaner contacts the surface of the second rotator and a separation position where the cleaner separates from the surface of the second rotator based on the temperature of the second rotator, that is detected by the temperature detector.

This specification further describes an improved image forming apparatus. In one embodiment, the image forming apparatus includes an image bearer that bears an image and a fixing device that fixes the image on a first sheet and a second sheet. The fixing device includes a first rotator that rotates in a first rotation direction and a second rotator that rotates in a second rotation direction. The second rotator is disposed opposite the first rotator to form a nip between the first rotator and the second rotator, through which the first sheet having a first width in an axial direction of the second rotator and the second sheet having a second width smaller than the first width in the axial direction of the second rotator are conveyed. A heater heats one of the first rotator and the second rotator. A cleaner is disposed opposite the second rotator. A temperature detector is disposed opposite the second rotator at an opposed position being within an increased conveyance span in the axial direction of the second rotator where the first sheet is conveyed. The opposed position is outboard from a decreased conveyance span in the axial direction of the second rotator where the second sheet is conveyed. The temperature detector detects a temperature of a surface of the second rotator. A mover moves the cleaner between a contact position where the cleaner contacts the surface of the second rotator and a separation position where the cleaner separates from the surface of the second rotator based on the temperature of the second rotator, that is detected by the temperature detector.

### BRIEF DESCRIPTION OF THE DRAWINGS

A more complete appreciation of the embodiments and many of the attendant advantages and features thereof can be readily obtained and understood from the following detailed description with reference to the accompanying drawings, wherein:

FIG. 1 is a cross-sectional view of an image forming apparatus according to an embodiment of the present disclosure, illustrating a general arrangement of components installed in the image forming apparatus;

FIG. 2 is a cross-sectional view of a fixing device incorporated in the image forming apparatus depicted in FIG. 1;

FIG. 3 is a cross-sectional view of the fixing device depicted in FIG. 2, illustrating a cleaning roller situated at a separation position;

FIG. 4 is a diagram of the fixing device depicted in FIG. 2, illustrating a main section of the fixing device in a width direction thereof;

FIG. 5A is a cross-sectional view of the fixing device depicted in FIG. 2, illustrating the cleaning roller situated at a contact position under a control performed when the fixing device is driven;

FIG. 5B is a cross-sectional view of the fixing device depicted in FIG. 3, illustrating the cleaning roller situated at the separation position under the control performed when the fixing device is driven;

FIG. 6A is a cross-sectional view of the cleaning roller and a pressure roller incorporated in the fixing device depicted in FIG. 2, illustrating toner disposed on the cleaning roller;

FIG. 6B is a cross-sectional view of the cleaning roller and the pressure roller depicted in FIG. 6A, illustrating the toner returned to the pressure roller;

FIG. 7 is a diagram of the cleaning roller and the pressure roller depicted in FIG. 6A, illustrating a temperature distribution of the cleaning roller in a width direction thereof when a plurality of small sheets is conveyed over the pressure roller continuously;

FIG. 8 is a timing chart of one example of contact and separation of the cleaning roller with respect to the pressure roller depicted in FIG. 6A;

FIG. 9 is a diagram of a fixing device as a first modification example of the fixing device depicted in FIG. 2, illustrating a main section of the fixing device in a width direction thereof;

FIG. 10 is a cross-sectional view of a fixing device as a second modification example of the fixing device depicted in FIG. 2;

FIG. 11A is a cross-sectional view of a fixing device as one of third modification examples of the fixing device depicted in FIG. 2; and

FIG. 11B is a cross-sectional view of a fixing device as another one of the third modification examples of the fixing device depicted in FIG. 2.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

As used herein, the singular forms “a”, “an”, and “the” are intended to include the plural forms as well, unless the context clearly indicates otherwise.

Referring to drawings, a detailed description is provided of embodiments of the present disclosure. In the drawings, identical reference numerals are assigned to identical elements and equivalents and redundant descriptions of the identical elements and the equivalents are summarized or omitted properly.

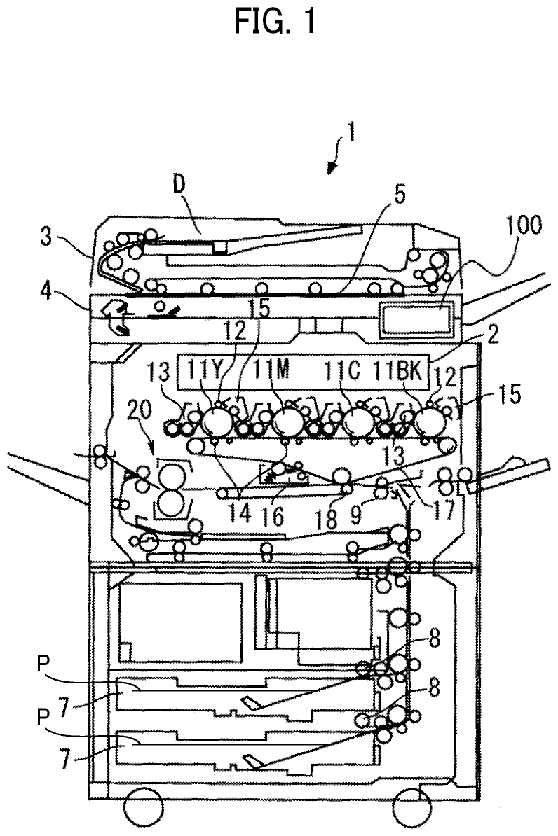

Referring to FIG. 1, a description is provided of an entire construction and operations of an image forming apparatus 1.

As illustrated in FIG. 1, the image forming apparatus 1 is a tandem color copier. A writer 2 emits a laser beam according to image data input thereto. An original conveyer 3 conveys an original D to an original reader 4. The original reader 4 reads an image on the original D into the image data.

Sheet feeders 7 load sheets P (e.g., paper). A registration roller pair 9 (e.g., a timing roller pair) adjusts a time when a sheet P is conveyed to an intermediate transfer belt 17. Photoconductive drums 11Y, 11M, 11C, and 11BK serving as image bearers bear yellow, magenta, cyan, and black toner images, respectively.

Chargers 12 charge surfaces of the photoconductive drums 11Y, 11M, 11C, and 11BK, respectively. Developing devices 13 develop electrostatic latent images formed on the surfaces of the photoconductive drums 11Y, 11M, 11C, and 11BK into yellow, magenta, cyan, and black toner images, respectively. Primary transfer bias rollers 14 transfer the yellow, magenta, cyan, and black toner images formed on the surfaces of the photoconductive drums 11Y, 11M, 11C, and 11BK, respectively, onto a surface of the intermediate transfer belt 17 such that the yellow, magenta, cyan, and black toner images are superimposed on the surface of the intermediate transfer belt 17. Cleaners 15 collect residual toner untransferred onto the intermediate transfer belt 17 and remained on the surfaces of the photoconductive drums 11Y, 11M, 11C, and 11BK, respectively.

An intermediate transfer belt cleaner 16 cleans the intermediate transfer belt 17. The intermediate transfer belt 17 bears a color toner image formed with the yellow, magenta, cyan, and black toner images as toner images in a plurality of colors, that are transferred and superimposed on the intermediate transfer belt 17. A secondary transfer bias roller 18 transfers the color toner image formed on the intermediate transfer belt 17 onto a sheet P. A fixing device 20 fixes the color toner image as an unfixed toner image on the sheet P.

A description is provided of processes for forming a color toner image, that is, processes for printing, which are performed by the image forming apparatus 1.

A conveying roller of the original conveyer 3 conveys an original D placed on an original tray to the original reader 4 so that the original D is placed on an exposure glass 5 of the original reader 4. The original reader 4 optically reads an image on the original D placed on the exposure glass 5.

Specifically, an illumination lamp of the original reader 4 emits light that irradiates and scans the image on the original D on the exposure glass 5. The light is reflected by the original D and travels through mirrors and a lens to a color sensor that forms an image. The color sensor reads and converts the image on the original D per color separation light of red (R), green (G), and blue (B) into electrical image signals. Based on the electrical image signals for each of separation colors of RGB, an image processor performs color conversion processing, color correction processing, spatial frequency correction processing, and the like, creating color image data, that is, yellow, magenta, cyan, and black image data.

The yellow, magenta, cyan, and black image data is sent to the writer 2. The writer 2 emits laser beams (e.g., exposure light) according to the yellow, magenta, cyan, and black image data onto the surfaces of the corresponding photoconductive drums 11Y, 11M, 11C, and 11BK, respectively.

On the other hand, the four photoconductive drums 11Y, 11M, 11C, and 11BK rotate counterclockwise in FIG. 1. The chargers 12 uniformly charge the surfaces of the photoconductive drums 11Y, 11M, 11C, and 11BK at charging positions where the photoconductive drums 11Y, 11M, 11C, and 11BK are disposed opposite the chargers 12, respectively, in a charging process. Thus, a charging electric potential is created on the surface of each of the photoconductive drums 11Y, 11M, 11C, and 11BK.

Thereafter, a charged portion on the surface of each of the photoconductive drums 11Y, 11M, 11C, and 11BK reaches an irradiation position where the writer 2 irradiates each of the photoconductive drums 11Y, 11M, 11C, and 11BK with a laser beam in an exposure process. Specifically, four light sources of the writer 2 emit laser beams according to the electrical image signals for yellow, magenta, cyan, and black, respectively. The laser beams travel through different optical paths for color components of yellow, magenta, cyan, and black, respectively.

The laser beam corresponding to a yellow component irradiates the surface of the photoconductive drum 11Y, that is, a leftmost photoconductive drum in FIG. 1. A polygon mirror rotating at high speed directs the laser beam corresponding to the yellow component to scan the photoconductive drum 11Y in an axial direction thereof, that is, a main scanning direction or a width direction. Thus, an electrostatic latent image corresponding to the yellow component is formed on the photoconductive drum 11Y charged by the charger 12.

Similarly, the laser beam corresponding to a magenta component irradiates the surface of the photoconductive drum 11M, that is, a second photoconductive drum from the left in FIG. 1, forming an electrostatic latent image corresponding to the magenta component. The laser beam corresponding to a cyan component irradiates the surface of the photoconductive drum 11C, that is, a third photoconductive drum from the left in FIG. 1, forming an electrostatic latent image corresponding to the cyan component. The laser beam corresponding to a black component irradiates the surface of the photoconductive drum 11BK, that is, a fourth photoconductive drum from the left in FIG. 1, forming an electrostatic latent image corresponding to the black component.

Thereafter, electrostatic latent image bearing portions on the surfaces of the photoconductive drums 11Y, 11M, 11C, and 11BK reach developing positions where the photoconductive drums 11Y, 11M, 11C, and 11BK are disposed opposite the developing devices 13, respectively. The developing devices 13 supply yellow, magenta, cyan, and black toners onto the surfaces of the photoconductive drums 11Y, 11M, 11C, and 11BK, respectively, developing the electrostatic latent images formed on the surfaces of the photoconductive drums 11Y, 11M, 11C, and 11BK into yellow, magenta, cyan, and black toner images in a developing process.

Thereafter, developed portions on the surfaces of the photoconductive drums 11Y, 11M, 11C, and 11BK reach primary transfer positions where the photoconductive drums 11Y, 11M, 11C, and 11BK are disposed opposite the intermediate transfer belt 17, respectively. At the primary transfer positions, the primary transfer bias rollers 14 contact an inner circumferential surface of the intermediate transfer belt 17. At the primary transfer positions, the primary transfer bias rollers 14 transfer the yellow, magenta, cyan, and black toner images formed on the surfaces of the photoconductive drums 11Y, 11M, 11C, and 11BK, respectively, onto the intermediate transfer belt 17 successively such that the yellow, magenta, cyan, and black toner images are superimposed on the intermediate transfer belt 17 in a primary transfer process, thus forming a color toner image on the intermediate transfer belt 17.

Transferred portions on the surfaces of the photoconductive drums 11Y, 11M, 11C, and 11BK reach cleaning positions where the photoconductive drums 11Y, 11M, 11C, and 11BK are disposed opposite the cleaners 15, respectively. The cleaners 15 collect residual toner untransferred onto the intermediate transfer belt 17 and remained on the surfaces of the photoconductive drums 11Y, 11M, 11C, and 11BK, respectively, in a cleaning process.

Thereafter, cleaned portions on the surfaces of the photoconductive drums 11Y, 11M, 11C, and 11BK pass under dischargers, respectively, thus finishing a series of processes for image formation performed on each of the photoconductive drums 11Y, 11M, 11C, and 11BK.

On the other hand, an image bearing portion on the intermediate transfer belt 17, that is transferred and superimposed with the yellow, magenta, cyan, and black toner images from the surfaces of the photoconductive drums 11Y, 11M, 11C, and 11BK, respectively, moves clockwise in FIG. 1 and reaches a secondary transfer position where the intermediate transfer belt 17 is disposed opposite the secondary transfer bias roller 18. At the secondary transfer position, the secondary transfer bias roller 18 transfers the color toner image formed on the intermediate transfer belt 17 onto a sheet P in a secondary transfer process.

Thereafter, a transferred portion on the surface of the intermediate transfer belt 17 reaches a cleaning position where the intermediate transfer belt 17 is disposed opposite the intermediate transfer belt cleaner 16. The intermediate transfer belt cleaner 16 collects untransferred toner adhered to the intermediate transfer belt 17, thus finishing a series of transfer processes performed on the intermediate transfer belt 17.

A secondary transfer nip is formed between the intermediate transfer belt 17 and the secondary transfer bias roller 18. A sheet P is conveyed from the sheet feeder 7 to the secondary transfer nip through the registration roller pair 9 and the like.

Specifically, a sheet feeding roller 8 feeds a sheet P from the sheet feeder 7 that loads a plurality of sheets P toward the registration roller pair 9 through a conveyance path. The registration roller pair 9 conveys the sheet P to the secondary transfer nip at a proper time.

A conveying belt conveys the sheet P transferred with the color toner image to the fixing device 20. In the fixing device 20, a fixing roller and a pressure roller form a nip, that is, a fixing nip, therebetween, where the fixing roller and the pressure roller fix the color toner image on a surface of the sheet P in a fixing process.

A sheet ejection roller ejects the sheet P bearing the fixed color toner image onto an outside of a body of the image forming apparatus 1 as an output image, thus finishing a series of processes for image formation, that is, a series of processes for printing.

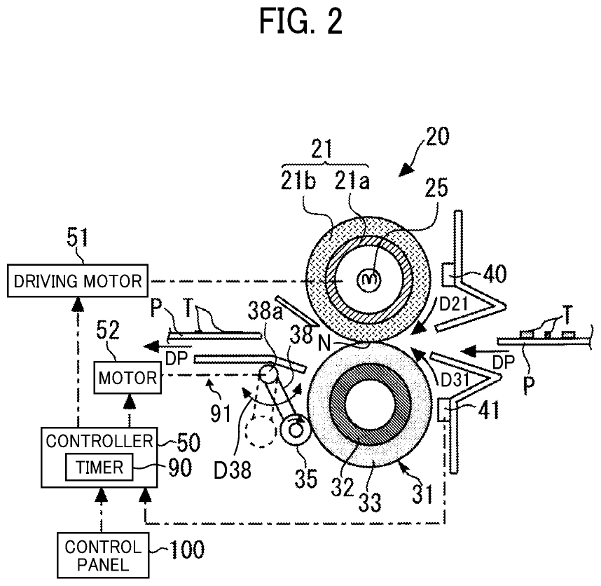

Referring to FIGS. 2 to 8, for example, a description is provided of a construction and operations of the fixing device 20 installed inside the body of the image forming apparatus 1 in detail.

As illustrated in FIG. 2, the fixing device 20 includes a fixing roller 21 serving as a fixing rotator or a fixing member, a heater 25 serving as a heater or a heat source, a pressure roller 31 serving as a pressure rotator or a pressure member, a cleaning roller 35 serving as a cleaner, a temperature sensor 40 that detects the temperature of the fixing roller 21, and a temperature sensor 41 serving as a temperature detector that detects the temperature of the pressure roller 31. The fixing device 20 further includes a mover 91 (e.g., a moving assembly) constructed of an arm 38 and a motor 52.

A detailed description is now given of a construction of the fixing roller 21.

The fixing roller 21 serving as a fixing rotator or a fixing member includes a cored bar 21a, an elastic layer 21b, and a release layer. The cored bar 21a is hollow and made of metal such as stainless steel. The fixing roller 21 is a roller having a multilayer structure in which the elastic layer 21b is layered on the cored bar 21a and the release layer is layered on the elastic layer 21b. The fixing roller 21 presses against the pressure roller 31 serving as a pressure rotator to form a nip, that is, a fixing nip N, therebetween.

The elastic layer 21b is made of an elastic material such as fluororubber, silicone rubber, and silicone rubber foam. The release layer is made of tetrafluoroethylene-perfluoroalkylvinylether copolymer (PFA) or the like. The release layer serving as a surface layer of the fixing roller 21 facilitates separation and peeling of toner T of a toner image formed on a sheet P from the fixing roller 21. A driving motor 51 serving as a driver drives and rotates the fixing roller 21 clockwise in FIG. 2.

A detailed description is now given of a configuration of the heater 25.

The heater 25 serving as a heater or a heat source is stationarily disposed inside the hollow, cored bar 21a of the fixing roller 21.

The heater 25 is a halogen heater. Both lateral ends of the heater 25 in a longitudinal direction thereof are secured to side plates of the fixing device 20, respectively. In a state in which a main switch of the body of the image forming apparatus 1 is turned on, a power supply supplies power to the heater 25. A controller 50 controls output of the heater 25. The heater 25 heats the fixing roller 21 with radiant heat. Heat is conducted from a surface of the fixing roller 21 heated by the heater 25 to the toner image on the sheet P.

The controller 50 controls output of the heater 25 based on a detection result provided by the temperature sensor 40, that is, the temperature of the surface of the fixing roller 21, that is detected by the temperature sensor 40 disposed opposite the surface of the fixing roller 21 without contacting the surface of the fixing roller 21. For example, the heater 25 is applied with an alternating current (AC) voltage for a predetermined energization time that is determined based on the temperature of the fixing roller 21, that is detected by the temperature sensor 40 (e.g., a thermopile). Such control of output of the heater 25 adjusts the temperature, that is, a fixing temperature, of the fixing roller 21 to a desired temperature (e.g., a target control temperature).

A detailed description is now given of a construction of the pressure roller 31 serving as a pressure rotator or a pressure member.

The pressure roller 31 is mainly constructed of a cored bar 32 and an elastic layer 33 disposed on an outer circumferential surface of the cored bar 32 via an adhesive layer. The elastic layer 33 is made of silicone rubber foam, fluororubber, silicone rubber, or the like. Optionally, a thin release layer made of PFA or the like may be disposed on a surface of the elastic layer 33.

A pressing assembly presses the pressure roller 31 against the fixing roller 21. Thus, the fixing nip N having a desired length in a sheet conveyance direction DP is formed between the pressure roller 31 and the fixing roller 21.

As the fixing roller 21 rotates in a rotation direction D21, the pressure roller 31 rotates counterclockwise in FIG. 2 in a rotation direction D31 in accordance with rotation of the fixing roller 21.

The fixing device 20 according to this embodiment includes the cleaning roller 35, the arm 38, the motor 52, and the temperature sensor 41 that are described below in detail. The cleaning roller 35 serves as a cleaner that removes a foreign substance, such as toner and paper dust, adhered to a surface of the pressure roller 31 therefrom, thus cleaning the surface of the pressure roller 31. The mover 91 constructed of the arm 38 and the motor 52 serves as the moving assembly that brings the cleaning roller 35 into contact with the pressure roller 31 and separates the cleaning roller 35 from the pressure roller 31. The temperature sensor 41 serves as the temperature detector that detects the temperature of a lateral end of the pressure roller 31 in an axial direction thereof.

A description is provided of operations of the fixing device 20 having the construction described above.

When the main switch of the body of the image forming apparatus 1 is turned on, the power supply applies an AC voltage to the heater 25, thus supplying power to the heater 25.

As the image forming apparatus 1 receives a print instruction (e.g., a print request), the driving motor 51 serving as the driver starts driving and rotating the fixing roller 21 clockwise in FIG. 2, starting rotation of the pressure roller 31 counterclockwise in accordance with rotation of the fixing roller 21. Thereafter, a sheet P is conveyed from the sheet feeder 7 to the secondary transfer nip formed by the secondary transfer bias roller 18. The secondary transfer bias roller 18 transfers a color toner image formed on the intermediate transfer belt 17 onto the sheet P as an unfixed toner image. The sheet P bearing the unfixed toner image is conveyed in the sheet conveyance direction DP depicted in FIG. 2. The sheet P enters the fixing nip N formed between the fixing roller 21 and the pressure roller 31 pressed against the fixing roller 21. The toner image is fixed on the surface of the sheet P under heat from the fixing roller 21 and pressure exerted by the fixing roller 21 and the pressure roller 31. After the toner image is fixed on the sheet P, the fixing roller 21 and the pressure roller 31 that rotate feed the sheet P in the sheet conveyance direction DP from the fixing nip N.

A detailed description is provided of a construction and operations of the fixing device 20 of the image forming apparatus 1 according to the embodiments of the present disclosure.

As described above with reference to FIGS. 1 and 2, the fixing device 20 includes the fixing roller 21 and the pressure roller 31. The fixing roller 21 serves as the fixing rotator that heats and fixes the toner image on the surface of the sheet P. The pressure roller 31 serves as the pressure rotator that is pressed against the fixing roller 21 to form the fixing nip N therebetween, through which the sheet P is conveyed.

The fixing device 20 further includes the cleaning roller 35 and the temperature sensor 41. The cleaning roller 35 serves as the cleaner that cleans the pressure roller 31. The temperature sensor 41 serves as the temperature detector that detects the temperature of the pressure roller 31.

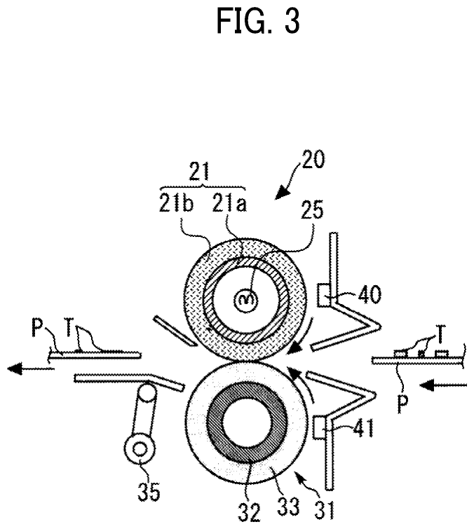

As illustrated in FIGS. 2 and 3, the mover 91 (e.g., the moving assembly) constructed of the arm 38 and the motor 52 moves the cleaning roller 35 serving as the cleaner between a contact position indicated with a solid line in FIG. 2 where the cleaning roller 35 contacts the surface of the pressure roller 31 serving as the pressure rotator and a separation position indicated with a dotted line in FIG. 2 and a solid line in FIG. 3 where the cleaning roller 35 separates from the surface of the pressure roller 31.

For example, according to this embodiment, the cleaning roller 35 is a roller made of metal and is rotatably supported by the arm 38. The cleaning roller 35 contacts the surface of the pressure roller 31 and removes the foreign substance, such as toner T and paper dust, adhered to the surface of the pressure roller 31 therefrom, thus cleaning the surface of the pressure roller 31. As the cleaning roller 35 cleans the surface of the pressure roller 31, the cleaning roller 35 cleans the pressure roller 31 directly and the fixing roller 21 indirectly, reducing a failure that the sheet P passing through the fixing nip N is stained with the toner T, the paper dust, and the like and a failure that a part of the toner image on the sheet P is damaged.

For example, according to this embodiment, in a state in which the cleaning roller 35 contacts the pressure roller 31 rotating in a predetermined direction (e.g., the rotation direction D31), the cleaning roller 35 rotates in accordance with rotation of the pressure roller 31. Accordingly, while the cleaning roller 35 rotates, the cleaning roller 35 changes a section on a surface that cleans the pressure roller 31, thus cleaning the pressure roller 31 effectively.

The arm 38 is pivotable about a support shaft 38a bidirectionally in a direction D38 depicted in FIG. 2. The arm 38 is supported by a frame of the fixing device 20. The motor 52 is coupled to the support shaft 38a supporting the arm 38 through a gear train. The motor 52 is a bidirectional motor that rotates forward and backward.

As the controller 50 controls the motor 52 to drive and rotate forward, the arm 38 pivots about the support shaft 38a counterclockwise in FIG. 2. Accordingly, as illustrated in FIG. 2, the cleaning roller 35 moves to the contact position and comes into contact with the pressure roller 31. Conversely, as the controller 50 controls the motor 52 to drive and rotate backward, the arm 38 pivots about the support shaft 38a clockwise in FIG. 2. Accordingly, as illustrated in FIG. 3, the cleaning roller 35 moves to the separation position and separates from the pressure roller 31.

Thus, the motor 52 and the arm 38 construct the mover 91 (e.g., the moving assembly) that moves the cleaning roller 35.

The mover 91 serving as the moving assembly constructed of the arm 38 and the motor 52 brings the cleaning roller 35 into contact with the pressure roller 31 and separates the cleaning roller 35 from the pressure roller 31. Accordingly, compared to a configuration in which the cleaning roller 35 contacts the pressure roller 31 constantly, the cleaning roller reduces failures such as solidification of the toner T at a nip formed between the pressure roller 31 and the cleaning roller 35 and deformation of the cleaning roller 35.

For example, if the cleaning roller 35 continues pressing against the pressure roller 31 for an extended period of time even after driving of the fixing device 20 stops, the toner T situated at the nip formed between the pressure roller 31 and the cleaning roller 35 may solidify in due course and the cleaning roller 35 and the pressure roller 31 may deform at the nip therebetween. To address this circumstance, according to this embodiment, the cleaning roller 35 that contacts and separates from the pressure roller 31 does not continue contacting the pressure roller 31 for the extended period of time while driving of the fixing device 20 stops, thus suppressing the failures described above.

As illustrated in FIGS. 2 to 4, the temperature sensor 41 serving as the temperature detector detects the temperature of the surface of the pressure roller 31 serving as the pressure rotator.

For example, as illustrated in FIGS. 2 and 3, the temperature sensor 41 is a non-contact type temperature sensor such as a thermopile and a non-contact type thermistor. The temperature sensor 41 is supported by the frame of the fixing device 20 such that a detecting face of the temperature sensor 41 is disposed opposite the pressure roller 31.

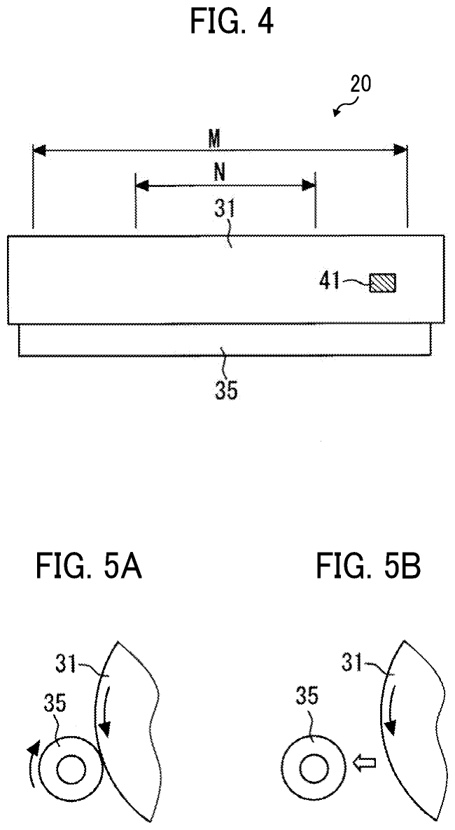

As illustrated in FIG. 4, the temperature sensor 41 serving as the temperature detector according to this embodiment detects the temperature of the surface of the pressure roller 31 serving as the pressure rotator contacted by the cleaning roller 35 at a position that is within a maximum conveyance span M and is outboard from a minimum conveyance span N in the axial direction of the pressure roller 31. For example, according to this embodiment, the temperature sensor 41 that detects the temperature of the pressure roller 31 is not disposed opposite a center of the pressure roller 31 but is disposed opposite the lateral end of the pressure roller 31 in the axial direction thereof. That is, the temperature sensor 41 is disposed within the maximum conveyance span M and outboard from the minimum conveyance span N in the axial direction of the pressure roller 31 as illustrated in FIG. 4.

The maximum conveyance span M defines a size, that is, a width, of a maximum sheet P in a width direction thereof, that is, the axial direction of the pressure roller 31. The width of the maximum sheet P is a maximum width among a plurality of sizes, that is, widths, of sheets P that are conveyed in the image forming apparatus 1. For example, the maximum width is a width of an A4 size sheet in landscape orientation or an A3 size sheet in portrait orientation. The minimum conveyance span N defines a size, that is, a width, of a minimum sheet P in a width direction thereof, that is, the axial direction of the pressure roller 31. The width of the minimum sheet P is a minimum width among a plurality of sizes, that is, widths, of sheets P that are conveyed in the image forming apparatus 1. For example, the minimum width is a width of a postcard.

In the fixing device 20 according to this embodiment, the controller 50 controls the mover 91 serving as the moving assembly constructed of the arm 38 and the motor 52 to move the cleaning roller 35 serving as the cleaner from the contact position depicted in FIG. 2 to the separation position depicted in FIG. 3 and from the separation position to the contact position based on a detection result provided by the temperature sensor 41 serving as the temperature detector, that is, a temperature of the pressure roller 31, that is detected by the temperature sensor 41.

For example, as illustrated in FIG. 5A, while the fixing device 20 is driven, if a detection result, that is, a temperature of the pressure roller 31, that is detected by the temperature sensor 41 serving as the temperature detector, is a predetermined value A or lower, the controller 50 controls the mover 91 serving as the moving assembly constructed of the arm 38 and the motor 52 to move the cleaning roller 35 to the contact position where the cleaning roller 35 contacts the pressure roller 31. Conversely, as illustrated in FIG. 5B, while the fixing device 20 is driven, if a detection result, that is, a temperature of the pressure roller 31, that is detected by the temperature sensor 41, is higher than the predetermined value A, the controller 50 controls the mover 91 serving as the moving assembly constructed of the arm 38 and the motor 52 to move the cleaning roller 35 to the separation position where the cleaning roller 35 separates from the pressure roller 31.

As described above, the fixing device 20 according to this embodiment does not incorporate a temperature sensor that detects the temperature of the surface of the cleaning roller 35 serving as the cleaner directly. The arm 38 and the motor 52 bring the cleaning roller 35 into contact with the pressure roller 31 or separates the cleaning roller 35 from the pressure roller 31 based on the detection result provided by the temperature sensor 41 that detects the temperature of the pressure roller 31 contacted by the cleaning roller 35.

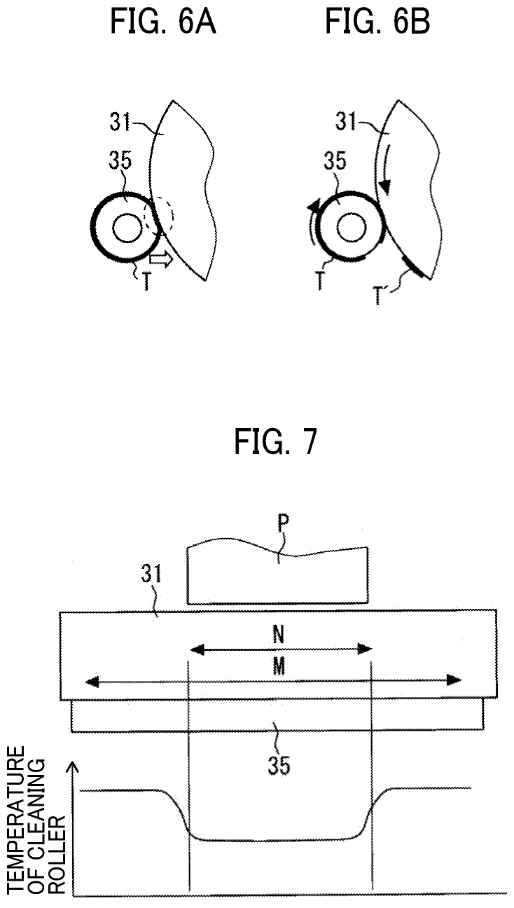

If the temperature of the cleaning roller 35 increases substantially and reaches a predetermined temperature (hereinafter referred to as a melting temperature properly), as illustrated in FIGS. 6A and 6B, a part T′ of the toner T as one of the foreign substance that adheres to the surface of the cleaning roller 35 may move or return to the surface of the pressure roller 31 disadvantageously. Hence, in order to reduce the failure that the foreign substance including the toner T adhered to the surface of the cleaning roller 35 returns to the surface of the pressure roller 31 while retaining proper cleaning performance of the cleaning roller 35, the temperature sensor 41 is requested to detect the temperature of the cleaning roller 35 precisely and the controller 50 is requested to control contact and separation of the cleaning roller 35 with respect to the pressure roller 31 based on the temperature of the pressure roller 31, that is detected by the temperature sensor 41.

However, even with a temperature sensor that detects the temperature of the cleaning roller 35 directly, if the surface of the cleaning roller 35 is stained with the toner T as illustrated in FIG. 6A, for example, the temperature sensor may not detect the temperature of the surface of the cleaning roller 35 precisely. Accordingly, the cleaning roller 35 that suffers from temperature increase may not separate from the pressure roller 31 at a proper time. The foreign substance including the toner T that adheres to the surface of the cleaning roller 35 may return to the surface of the pressure roller 31 disadvantageously. Consequently, the surface of the pressure roller 31 may be stained, thus staining the sheet P conveyed through the fixing nip N and damaging a part of the toner image formed on the sheet P. The foreign substance returned to the pressure roller 31 may produce an uneven layer of the foreign substance adhered to the surface of the cleaning roller 35, causing faulty rotation of the cleaning roller 35.

A description is provided of a construction of a comparative fixing device.

The comparative fixing device includes a fixing rotator (e.g., a heating roller) and a pressure rotator (e.g., a pressure roller) pressed against the fixing rotator to form a nip (e.g., a fixing nip) therebetween, through which a sheet serving as a recording medium is conveyed. While the sheet bearing a toner image is conveyed through the nip, the toner image is fixed on the sheet under heat conducted from the fixing rotator and pressure exerted at the nip.

The comparative fixing device further includes a cleaner (e.g., a cleaning roller) that moves to contact and separate from the pressure rotator. As the cleaner contacts the pressure rotator, the cleaner cleans a surface of the pressure rotator.

In order to prevent toner from melting and leaking from the cleaner due to temperature increase, the cleaner separates from the surface of the pressure rotator based on a temperature of a surface of the cleaner, that is detected by a temperature sensor.

Even with the temperature sensor that detects the temperature of the cleaner, if the surface of the cleaner is stained with toner, for example, the temperature sensor may not detect the temperature of the surface of the cleaner precisely. Accordingly, the cleaner that suffers from temperature increase may not separate from the pressure rotator at a proper time. Hence, a foreign substance, such as toner, adhered to the surface of the cleaner may return to the surface of the fixing rotator or the pressure rotator disadvantageously. Consequently, the surface of the fixing rotator or the pressure rotator may be stained, thus staining the sheet conveyed through the nip and damaging a part of the toner image on the sheet. The foreign substance returned to the fixing rotator or the pressure rotator may produce an uneven layer of the foreign substance adhered to the surface of the cleaner, causing faulty rotation of the cleaner.

To address this circumstance, the fixing device 20 according to this embodiment does not employ the temperature sensor that detects the temperature of the surface of the cleaning roller 35 directly. The temperature sensor 41 detects the temperature of the surface of the pressure roller 31 contacted by the cleaning roller 35. The controller 50 controls the arm 38 and the motor 52 to bring the cleaning roller 35 into contact with the pressure roller 31 and separate the cleaning roller 35 from the pressure roller 31 based on the temperature of the pressure roller 31, that is detected by the temperature sensor 41. Unlike the surface of the cleaning roller 35, the surface of the pressure roller 31 barely suffers from substantial change in an amount of stains over time. Hence, the temperature sensor 41 detects the temperature of the surface of the cleaning roller 35 indirectly and precisely. Thus, the temperature sensor 41 reduces the failure that the foreign substance including the toner T adhered to the cleaning roller 35 returns to the surface of the pressure roller 31. According to this embodiment, the temperature sensor 41 is a non-contact type temperature sensor, reducing a failure that the surface of the temperature sensor 41 is stained with the toner T and the like and suffers from decrease in detection accuracy.

The predetermined value A described above, that is, the melting temperature, defines an upper limit temperature (e.g., a temperature of the surface of the pressure roller 31) at which the foreign substance, that is, the toner T mainly, which moves from the surface of the pressure roller 31 to the surface of the cleaning roller 35, does not return to the surface of the pressure roller 31.

According to this embodiment, the controller 50 controls contact and separation of the cleaning roller 35 with respect to the pressure roller 31 not based on a temperature of the center of the pressure roller 31 in the axial direction thereof but based on a temperature of the lateral end of the pressure roller 31 in the axial direction thereof. The lateral end is disposed within the maximum conveyance span M and outboard from the minimum conveyance span N in the axial direction of the pressure roller 31.

It is because, when a plurality of small sheets P (e.g., postcards) is conveyed in the minimum conveyance span N continuously, as illustrated in FIG. 7, a temperature distribution of the cleaning roller 35 in an axial direction thereof indicates temperature increase at both lateral ends of the cleaning roller 35 in the axial direction thereof, that is, a non-conveyance span where the small sheets P are not conveyed. This phenomenon occurs similarly in a temperature distribution of each of the pressure roller 31 and the fixing roller 21. For example, the small sheets P draw heat from the pressure roller 31 and the fixing roller 21 in the minimum conveyance span N, decreasing the temperature of the pressure roller 31, the fixing roller 21, and the cleaning roller 35 in the minimum conveyance span N. Conversely, the small sheets P do not draw heat from the pressure roller 31 and the fixing roller 21 in the non-conveyance span, increasing the temperature of the pressure roller 31, the fixing roller 21, and the cleaning roller 35 in the non-conveyance span.

Accordingly, with the temperature distribution depicted in FIG. 7, if the controller 50 controls contact and separation of the cleaning roller 35 with respect to the pressure roller 31 based on the temperature of the pressure roller 31 in the minimum conveyance span N, that is, the center of the pressure roller 31 in the axial direction thereof, the foreign substance including the toner T may return to both lateral ends of the pressure roller 31 in the axial direction thereof from overheated lateral ends of the cleaning roller 35 in the axial direction thereof, respectively. When conveyance of the small sheet P finishes and a large sheet P is conveyed, the toner T returned to both lateral ends of the pressure roller 31 in the axial direction thereof may adhere to the large sheet P.

To address this circumstance, according to this embodiment, the controller 50 controls contact and separation of the cleaning roller 35 with respect to the pressure roller 31 based on the temperature of the lateral end of the pressure roller 31 in the axial direction thereof, that is disposed within the maximum conveyance span M and outboard from the minimum conveyance span N in the axial direction of the pressure roller 31. Accordingly, the fixing device 20 reduces the failure that the foreign substance including the toner T adhered to the surface of the cleaning roller 35 returns to the surface of the pressure roller 31 while retaining proper cleaning performance of the cleaning roller 35.

According to this embodiment, the controller 50 corrects the detection result of the temperature sensor 41 serving as the temperature detector, that is, the temperature of the pressure roller 31, that is detected by the temperature sensor 41, based on at least one of the size of the sheet P in the width direction thereof, that is conveyed through the fixing nip N, and the driving time (e.g., the print time) of the fixing device 20.

For example, the temperature of the pressure roller 31, that is detected by the temperature sensor 41, is corrected based on the size of the sheet P in the width direction thereof and the print time. If the corrected temperature of the pressure roller 31 is the predetermined value A or lower, the cleaning roller 35 does not separate from the pressure roller 31. If the corrected temperature of the pressure roller 31 is higher than the predetermined value A, the cleaning roller 35 separates from the pressure roller 31.

For example, when the small sheet P having a width smaller than a width of the large sheet P in the width direction thereof is conveyed through the fixing device 20, both lateral ends of the cleaning roller 35 in the axial direction thereof are subject to overheating as described above with reference to FIG. 7, returning the toner T to the pressure roller 31 easily. To address this circumstance, in order to separate the cleaning roller 35 from the pressure roller 31 in advance, the temperature of the pressure roller 31, that is detected by the temperature sensor 41, is corrected to a relatively higher temperature. The controller 50 may detect the size of the sheet P in the width direction thereof based on information about the sheet P, that is input by a user with a control panel 100 depicted in FIG. 1. Alternatively, a sheet size sensor may detect the size of the sheet P in the width direction thereof. The sheet size sensor is a sensor that detects the size of the sheet P in the width direction thereof directly.

In a case in which printing is performed for an extended print time, compared to a case in which printing is performed for a shortened print time, both lateral ends of the cleaning roller 35 in the axial direction thereof are subject to overheating as described above with reference to FIG. 7, returning the toner T to the pressure roller 31 easily. To address this circumstance, in order to separate the cleaning roller 35 from the pressure roller 31 in advance, the temperature of the pressure roller 31, that is detected by the temperature sensor 41, is corrected to a relatively higher temperature. A timer 90 installed in the controller 50 depicted in FIG. 2 detects the print time.

The controller 50 performs control as described above, facilitating attainment of the above-described advantages of the fixing device 20.

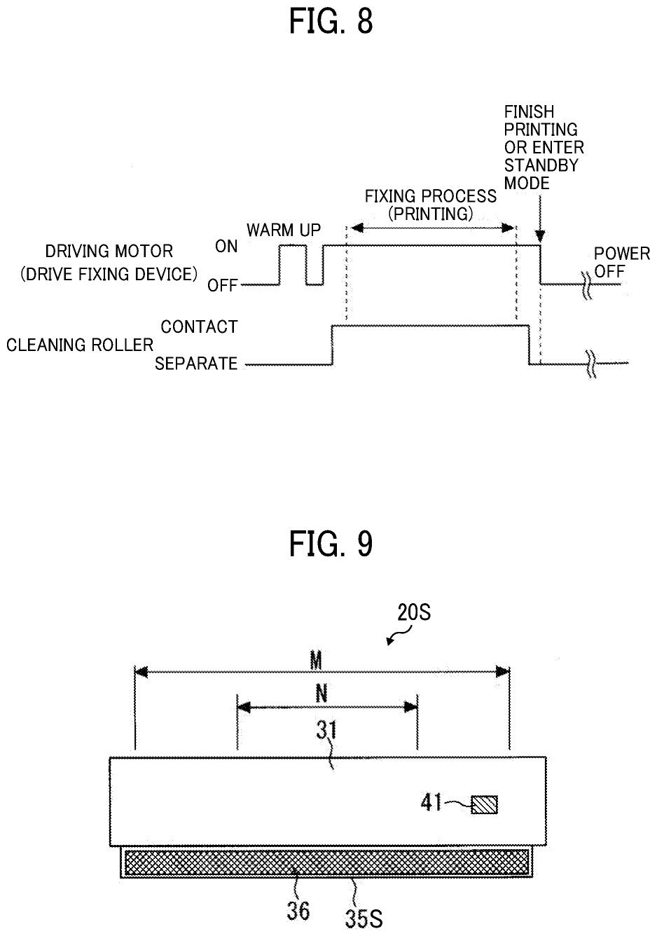

As illustrated in FIG. 8, according to this embodiment, the controller 50 controls the arm 38 and the motor 52 to move the cleaning roller 35 to the separation position when the fixing device 20 is warmed up.

For example, when the fixing device 20 is warmed up as a main power supply of the image forming apparatus 1 is turned on or when the fixing device 20 is warmed up immediately after the image forming apparatus 1 resumes operation after a standby mode (e.g., a sleep mode for energy saving in which power supply to the heater 25 of the fixing device 20 decreases), the controller 50 controls the mover 91 serving as the moving assembly constructed of the arm 38 and the motor 52 to have the cleaning roller 35 moved to the separation position.

If the cleaning roller 35 contacts the pressure roller 31 when the fixing device 20 is warmed up, the cleaning roller 35 draws heat from the pressure roller 31, causing a failure of increasing a warmup time period. To address this circumstance, according to this embodiment, when the fixing device 20 is warmed up, the cleaning roller 35 has moved to the separation position, reducing the failure described above.

Additionally, as illustrated in FIG. 8, according to this embodiment, when driving of the fixing device 20 finishes, for example, when the driving motor 51 stops driving the fixing roller 21 as the fixing process finishes, the controller 50 controls the arm 38 and the motor 52 to move the cleaning roller 35 to the separation position.

For example, when the fixing process finishes, printing finishes and the main power supply is turned off or the image forming apparatus 1 enters the standby mode. To address this circumstance, before printing finishes or the image forming apparatus 1 enters the standby mode after the fixing process, the controller 50 controls the mover 91 serving as the moving assembly constructed of the arm 38 and the motor 52 to move the cleaning roller 35 to the separation position.

If the cleaning roller 35 contacts the pressure roller 31 after driving of the fixing device 20 finishes, the toner T situated at an abutment (e.g., the nip) between the cleaning roller 35 and the pressure roller 31 may solidify in due course or the cleaning roller 35 and the pressure roller 31 may deform at the abutment therebetween. To address this circumstance, according to this embodiment, the cleaning roller 35 that contacts and separates from the pressure roller 31 does not continue contacting the pressure roller 31 after driving of the fixing device 20 stops, thus suppressing the failures described above.

A description is provided of a construction of a fixing device 20S as a first modification example of the fixing device 20.

FIG. 9 is a diagram of the fixing device 20S as the first modification example of the fixing device 20, illustrating a main section of the fixing device 20S in a width direction thereof. FIG. 9 corresponds to FIG. 4 illustrating the fixing device 20.

As illustrated in FIG. 9, the fixing device 20S as the first modification example of the fixing device 20 includes a cleaning roller 35S that accommodates a heat pipe 36. The heat pipe 36 suppresses temperature increase of the cleaning roller 35S advantageously, reducing the failure that the toner T and the like return to the pressure roller 31 from the cleaning roller 35S.

According to the first modification example, the heat pipe 36 is disposed in a part of the cleaning roller 35S. Alternatively, the heat pipe 36 may be disposed in an entirety of the cleaning roller 35S.

A description is provided of a construction of a fixing device 20T as a second modification example of the fixing device 20.

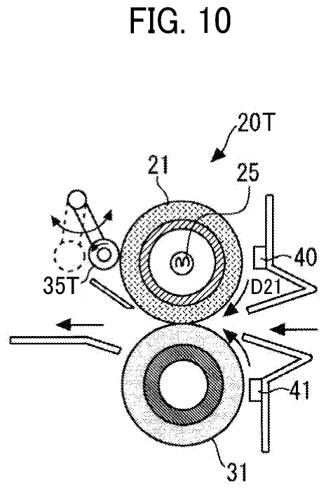

FIG. 10 is a cross-sectional view of the fixing device 20T as the second modification example of the fixing device 20, illustrating a main section of the fixing device 20T. FIG. 10 corresponds to FIG. 2 illustrating the fixing device 20.

As illustrated in FIG. 10, the fixing device 20T according to the second modification example includes a cleaning roller 35T serving as a cleaner that contacts and cleans the surface of the fixing roller 21 serving as the fixing rotator. In a state in which the cleaning roller 35T contacts the fixing roller 21 rotating in the predetermined direction (e.g., the rotation direction D21), the cleaning roller 35T rotates in accordance with rotation of the fixing roller 21.

Like the fixing device 20, the fixing device 20T according to the second modification example also does not incorporate a temperature sensor that detects the temperature of a surface of the cleaning roller 35T directly. The fixing device 20T incorporates the temperature sensor 40 that detects the temperature of the surface of the fixing roller 21. The temperature sensor 40 serves as a temperature detector that detects the temperature of the surface of the fixing roller 21 at a position that is within the maximum conveyance span M and is disposed outboard from the minimum conveyance span N in the axial direction of the fixing roller 21.

Like the fixing device 20, the fixing device 20T according to the second modification example includes the controller 50 that controls contact and separation of the cleaning roller 35T with respect to the fixing roller 21 based on a detection result provided by the temperature sensor 40, that is, the temperature of the surface of the fixing roller 21, that is detected by the temperature sensor 40.

The fixing device 20T having the construction described above reduces the failure that the foreign substance adhered to the surface of the cleaning roller 35T returns to the surface of the fixing roller 21 while retaining proper cleaning performance of the cleaning roller 35T.

A description is provided of a construction of each of fixing devices 20U and 20V as third modification examples of the fixing device 20.

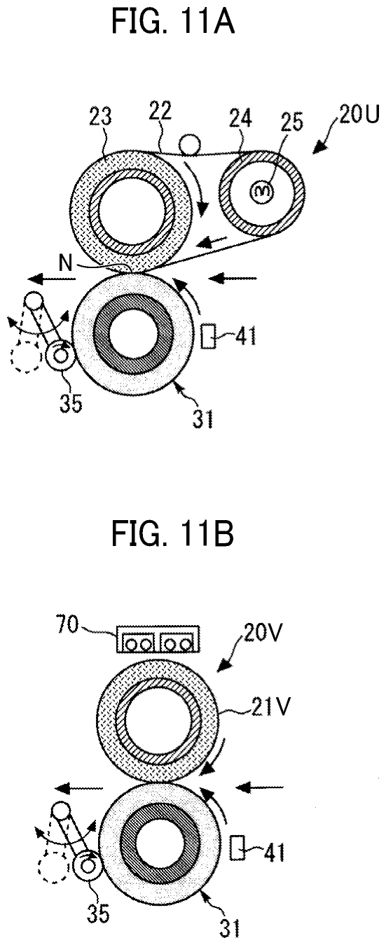

FIG. 11A is a cross-sectional view of the fixing device 20U as one of the third modification examples of the fixing device 20. FIG. 11B is a cross-sectional view of the fixing device 20V as another one of the third modification examples of the fixing device 20. FIGS. 11A and 11B correspond to FIG. 2 illustrating the fixing device 20.

The constructions according to the embodiments of the present disclosure are applied to the fixing devices 20, 20S, and 20T as roller type fixing devices employing a thermal heating method. However, application of the constructions according to the embodiments of the present disclosure is not limited to the fixing devices 20, 20S, and 20T as the roller type fixing devices employing the thermal heating method. The constructions according to the embodiments of the present disclosure are applicable to fixing devices employing various methods.

For example, as illustrated in FIG. 11A, the constructions according to the embodiments of the present disclosure are also applied to the fixing device 20U that is a belt type fixing device employing the thermal heating method. The fixing device 20U includes a fixing belt 22 serving as a fixing rotator. The fixing belt 22 is stretched taut across and supported by a plurality of rollers including a supplementary fixing roller 23, a heating roller 24, and a tension roller. The supplementary fixing roller 23 presses against the pressure roller 31 via the fixing belt 22 to form the fixing nip N between the fixing belt 22 and the pressure roller 31. The heater 25 is stationarily disposed inside the hollow, heating roller 24.

Alternatively, as illustrated in FIG. 11B, the constructions according to the embodiments of the present disclosure are also applied to the fixing device 20V that is a roller type fixing device employing an electromagnetic induction heating (IH) method. The fixing device 20V includes a fixing roller 21V that includes a cored bar, an elastic layer, a heat generating layer, and a release layer. The elastic layer is layered on the cored bar. The heat generating layer is layered on the elastic layer. An induction heater 70 including an exciting coil that is wound round causes the heat generating layer to generate heat by electromagnetic induction. The release layer is layered on the heat generating layer.

Alternatively, the constructions according to the embodiments of the present disclosure are also applicable to a fixing device that is a roller type fixing device employing a resistive heat generation method. The fixing device employing the resistive heat generation method includes a fixing roller that includes a cored bar, a resistive heat generator, an elastic layer, and a release layer. The resistive heat generator contacts a hollow portion of the cored bar. The elastic layer is layered on the cored bar. The release layer is layered on the elastic layer.

The fixing device employing the resistive heat generation method attains advantages substantially similar to the advantages of the fixing device 20.

As described above, each of the fixing devices 20, 20S, 20T, 20U, and 20V according to the embodiments of the present disclosure includes the mover 91 serving as the moving assembly constructed of the arm 38 and the motor 52. The mover 91 moves the cleaning roller 35, 35S, or 35T serving as the cleaner between the contact position where the cleaning roller 35, 35S, or 35T contacts the surface of the pressure roller 31 serving as the pressure rotator or the fixing roller 21 serving as the fixing rotator and the separation position where the cleaning roller 35, 35S, or 35T separates from the surface of the pressure roller 31 or the fixing roller 21.

Each of the fixing devices 20, 20S, 20T, 20U, and 20V further includes the temperature sensor 41 serving as the temperature detector that is disposed opposite the pressure roller 31 or the temperature sensor 40 serving as the temperature detector that is disposed opposite the fixing roller 21 at a position disposed within the maximum conveyance span M and disposed outboard from the minimum conveyance span N in the axial direction of the pressure roller 31 or the fixing roller 21, thus detecting the temperature of the surface of the pressure roller 31 or the fixing roller 21 at a position disposed within the maximum conveyance span M and disposed outboard from the minimum conveyance span N in the axial direction of the pressure roller 31 or the fixing roller 21.

The mover 91 serving as the moving assembly constructed of the arm 38 and the motor 52 moves the cleaning roller 35, 35S, or 35T from the contact position to the separation position and from the separation position to the contact position based on the detection result provided by the temperature sensor 41 or 40, that is, the temperature of the surface of the pressure roller 31 or the fixing roller 21, that is detected by the temperature sensor 41 or 40.

Thus, each of the fixing devices 20, 20S, 20T, 20U, and 20V reduces the failure that the foreign substance adhered to the surface of the cleaning roller 35, 35S, or 35T returns to the surface of the pressure roller 31 or the fixing roller 21.

According to the embodiments of the present disclosure, the pressure roller 31 is used as the pressure rotator. Alternatively, a pressure belt may be used as a pressure rotator.

Each of the fixing devices 20, 20S, 20T, 20U, and 20V may further include a cooler that contacts and cools the cleaning roller 35, 35S, or 35T serving as the cleaner that is situated at the separation position. The cooler prevents temperature increase or overheating of the cleaning roller 35, 35S, or 35T.

In this case also, each of the fixing devices 20, 20S, 20T, 20U, and 20V attains advantages similar to the advantages described above.

The technology of the present disclosure is not limited to the embodiments described above. The embodiments of the present disclosure are modified properly to configurations or constructions other than those suggested in the embodiments described above within the scope of the technology of the present disclosure. The number, the position, the shape, and the like of the components according to the embodiments of the present disclosure are not limited to those suggested in the embodiments described above and are modified to the number, the position, the shape, and the like that are appropriate to achieve the technology of the present disclosure.

According to the present disclosure, the width direction defines a direction perpendicular to the sheet conveyance direction DP.

The sheet P defines a recording medium having a sheet shape, such as plain paper, coated paper, a label sheet, an overhead projector (OHP) transparency, and a film sheet.

A description is provided of advantages of a fixing device (e.g., the fixing devices 20, 20S, 20T, 20U, and 20V).

As illustrated in FIG. 2, the fixing device includes a first rotator or a fixing rotator (e.g., the fixing roller 21 depicted in FIG. 2, the pressure roller 31 depicted in FIG. 10, the fixing belt 22 depicted in FIG. 11A, and the fixing roller 21V depicted in FIG. 11B), a second rotator or a pressure rotator (e.g., the pressure roller 31 depicted in FIGS. 2, 11A, and 11B and the fixing roller 21 depicted in FIG. 10), a cleaner (e.g., the cleaning rollers 35, 35S, and 35T), a mover (e.g., the mover 91 constructed of the arm 38 and the motor 52), and a temperature detector (e.g., the temperature sensor 40 depicted in FIG. 10 and the temperature sensor 41 depicted in FIGS. 2, 11A, and 11B).

The first rotator heats and fixes a toner image on a surface of a sheet (e.g., a sheet P). The second rotator presses against the first rotator to form a nip (e.g., the fixing nip N) therebetween, through which the sheet bearing the toner image is conveyed. For example, a first sheet having a first width in an axial direction of the second rotator and a second sheet having a second width smaller than the first width in the axial direction of the second rotator are conveyed through the nip. The cleaner is disposed opposite one of the first rotator and the second rotator and cleans a surface of the one of the first rotator and the second rotator. The mover moves the cleaner between a contact position where the cleaner contacts the surface of the one of the first rotator and the second rotator and a separation position where the cleaner separates from the surface of the one of the first rotator and the second rotator.

The temperature detector is disposed opposite the one of the first rotator and the second rotator at an opposed position that is within an increased conveyance span (e.g., the maximum conveyance span M) where the first sheet is conveyed and is outboard from a decreased conveyance span (e.g., the minimum conveyance span N) where the second sheet is conveyed in an axial direction of the one of the first rotator and the second rotator. The temperature detector detects a temperature of the surface of the one of the first rotator and the second rotator.

The mover moves the cleaner from the contact position to the separation position and from the separation position to the contact position based on a detection result provided by the temperature detector, that is, the temperature of the one of the first rotator and the second rotator, that is detected by the temperature detector.

Accordingly, the fixing device and an image forming apparatus incorporating the fixing device reduce a failure that a foreign substance adhered to a surface of the cleaner returns to the surface of the first rotator or the second rotator.

According to the embodiments described above, the fixing rollers 21 and 21V and the fixing belt 22 serve as a fixing rotator. Alternatively, a fixing film, a fixing sleeve, or the like may be used as a fixing rotator. Further, the pressure roller 31 serves as a pressure rotator. Alternatively, a pressure belt or the like may be used as a pressure rotator.

The above-described embodiments are illustrative and do not limit the present disclosure. Thus, numerous additional modifications and variations are possible in light of the above teachings. For example, elements and features of different illustrative embodiments may be combined with each other and substituted for each other within the scope of the present disclosure.

Any one of the above-described operations may be performed in various other ways, for example, in an order different from the one described above.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

What is claimed is:

1. A fixing device comprising:
a first rotator configured to rotate in a first rotation direction;
a second rotator configured to rotate in a second rotation direction, the second rotator disposed opposite the first rotator to form a nip between the first rotator and the second rotator, the nip through which a first sheet having a first width in an axial direction of the second rotator and a second sheet having a second width smaller than the first width in the axial direction of the second rotator are conveyed;
a heater configured to heat one of the first rotator and the second rotator;
a cleaner disposed opposite the second rotator;
a temperature detector disposed opposite the second rotator at an opposed position being within an increased conveyance span in the axial direction of the second rotator where the first sheet is conveyed, the opposed position being outboard from a decreased conveyance span in the axial direction of the second rotator where the second sheet is conveyed, the temperature detector configured to detect a temperature of a surface of the second rotator; and
a mover configured to move the cleaner between a contact position where the cleaner contacts the surface of the second rotator and a separation position where the cleaner separates from the surface of the second rotator based on the temperature of the second rotator, the temperature detected by the temperature detector.

2. The fixing device according to claim 1,
wherein the mover moves the cleaner to the contact position when the temperature of the second rotator, that is detected by the temperature detector, is a predetermined temperature or lower, and
wherein the mover moves the cleaner to the separation position when the temperature of the second rotator, that is detected by the temperature detector, is higher than the predetermined temperature.

3. The fixing device according to claim 1, further comprising a controller configured to correct the temperature of the second rotator, that is detected by the temperature detector, based on at least one of a size of one of the first sheet and the second sheet in the axial direction of the second rotator and a driving time of the fixing device.

4. The fixing device according to claim 1,
wherein the mover moves the cleaner to the separation position when the heater warms up the fixing device.

5. The fixing device according to claim 1, further comprising a driver configured to drive the first rotator,
wherein the mover moves the cleaner to the separation position when the driver stops driving the first rotator.

6. The fixing device according to claim 1,
wherein the cleaner includes a cleaning roller configured to rotate in accordance with rotation of the second rotator in the second rotation direction when the cleaning roller contacts the second rotator.

7. The fixing device according to claim 6, further comprising a heat pipe accommodated in the cleaning roller.

8. The fixing device according to claim 7,
wherein the heat pipe is disposed in a part of the cleaning roller.

9. The fixing device according to claim 7,
wherein the heat pipe is disposed in an entirety of the cleaning roller.

10. The fixing device according to claim 1,
wherein the temperature detector includes a non-contact type temperature sensor configured to detect the temperature of the second rotator without contacting the second rotator, and
wherein the non-contact type temperature sensor does not detect a temperature of a surface of the cleaner directly.

11. The fixing device according to claim 1,
wherein the first rotator includes a fixing roller configured to heat and fix an image on the first sheet and the second sheet.

12. The fixing device according to claim 1,
wherein the first rotator includes a fixing belt configured to heat and fix an image on the first sheet and the second sheet.

13. The fixing device according to claim 1,
wherein the second rotator includes a pressure roller configured to press against the first rotator.

14. The fixing device according to claim 1,
wherein the second rotator includes a fixing roller configured to heat and fix an image on the first sheet and the second sheet.

15. The fixing device according to claim 1,
wherein the mover includes:
an arm coupled to the cleaner and configured to pivot; and
a motor coupled to the arm and configured to pivot the arm.

16. The fixing device according to claim 1,
wherein the heater includes a halogen heater.

17. The fixing device according to claim 1,
wherein the heater includes an induction heater.

18. An image forming apparatus comprising:
an image bearer configured to bear an image; and
a fixing device configured to fix the image on a first sheet and a second sheet,
the fixing device including:
a first rotator configured to rotate in a first rotation direction;
a second rotator configured to rotate in a second rotation direction, the second rotator disposed opposite the first rotator to form a nip between the first rotator and the second rotator, the nip through which the first sheet having a first width in an axial direction of the second rotator and the second sheet having a second width smaller than the first width in the axial direction of the second rotator are conveyed;
a heater configured to heat one of the first rotator and the second rotator;
a cleaner disposed opposite the second rotator;
a temperature detector disposed opposite the second rotator at an opposed position being within an increased conveyance span in the axial direction of the second rotator where the first sheet is conveyed, the opposed position being outboard from a decreased conveyance span in the axial direction of the second rotator where the second sheet is conveyed, the temperature detector configured to detect a temperature of a surface of the second rotator; and
a mover configured to move the cleaner between a contact position where the cleaner contacts the surface of the second rotator and a separation position where the cleaner separates from the surface of the second rotator based on the temperature of the second rotator, the temperature detected by the temperature detector.
